(19) United States
(12) Patent Application Publication
(10) Pub. No.: US 2001/0021920 A1
(43) Pub. Date: Sep. 13, 2001

(54) Method of giving gifts via online network

(76) Inventor: Fumiko Ikeda, Mino-shi (JP)

Correspondence Address: MERCHANT & GOULD PC, P.O. BOX 2903, MINNEAPOLIS, MN, 55402-0903, US

(21) Appl. No.: 09/803,408

(22) Filed: Mar. 9, 2001

(30) Foreign Application Priority Data
Mar. 10, 2000 (JP) 2000-067826

(51) Int. Cl. G06F 17/60

(52) U.S. Cl. 705/26; 705/80

(57) ABSTRACT

The present invention provides a method of giving gifts via online networks wherein the users who are gift senders jointly own the virtual space which utilizes communication networks and a symbol defined for each user in the said virtual space and when users exchange messages in the virtual space, gift senders select and give gifted goods for gift recipients.

In addition, referring to the information on gift recipients (hobbies or preferences), gift dealers handling gifts propose the preferable goods to gift senders. Gifted goods is decided by majority. Then, claimants of the bill charge the amount divided equally to each gift sender.

### FIELD OF THE INVENTION

The present invention relates to a method of giving gifts, purchasing goods and settlement via online networks using communication networks.

### DESCRIPTION OF THE PRIOR ART

Heretofore, in sending gifted goods (hereafter, it may be abbreviated as goods), gift senders gather together to decide what goods to buy. When they do not have an opportunity for gathering, they used to decide goods for purchase by contacting each other over the telephone, and the like. Further, the amount for goods was paid by one of the gift senders, who also paid for other senders. Therefore, the amount to be paid for others was collected later. Further, in many cases, gift senders found it difficult to find their favorite goods.

In many cases, it is difficult for gift senders to gather together in order to decide what goods to buy. It takes time to decide the goods for purchase by contacting over telephone and the like. Further, collecting the amount to be paid for other senders later causes a person who paid for others financial burden, tentatively though, as well as troublesome.

### SUMMARY OF THE INVENTION

As a result of intensive studies, the present invention adopted a method of giving gifts via online networks by utilizing communication networks wherein the users who are gift senders jointly own the virtual space and the symbols defined for each user in the said virtual space, and by exchanging messages in this virtual space, the users or gift senders select and give gifts to gift recipients.

Therefore, in the present invention, users can talk each other over the networks as if they met each other even though they do not meet actually, and gift senders can select gifts and give such gifts to gift recipients. In other words, gift senders can send goods to gift recipients actually when the avatar related to the gift sender selects virtual goods and purchases goods as if they did shopping in the virtual space.

In particular, since communication networks are utilized, each user can select and give gifts as if they met each other and talked each other by using the devices that can be connected to the communication networks (hereafter, it may be called the “network device”) either at home or any other places. Therefore, the user does not have to go to stores handling gifts. In addition, the user can order gifts at any time without worrying about the time.

In the present invention, such a method of purchasing gifts and settlement via online network is preferable that at least a virtual store is provided in the virtual space and gift senders select and give gifts to gift recipients by utilizing the said virtual store. Thus, when the virtual space is provided on the screen of network device including computers and the like, gift senders can enjoy selecting gifts furthermore, since they can select gifts as if the users as gift senders enjoyed shopping.

Of course, the method of giving gifts of the present invention can be adopted not only to select gifted goods but also for purchasers to select the goods jointly purchased.

In the method of settlement via online networks of the present invention, it is particularly preferable that the claimants for the bill (including dealers handling gifts, financial companies acting for claiming the bill, or the like) have such a system as charging the amount of the gifts to gift senders by automatically dividing the share amount equally. When such a system is adopted, since the amount of the payment per sender is automatically divided equally and charged thereafter, gift senders do not have to calculate the amount per sender. In addition, the representative of gift senders does not have to collect the amount from each gift sender and make payment to dealers handling gifts.

### BRIEF DESCRIPTION OF THE DRAWINGS

FIG. 1 shows the flow chart showing the method of giving gifts via online networks and settlement of the present invention.

FIG. 2 is the figure showing the structural example of the chatting system of the present invention.

FIG. 3 is the example of the screen on which the decision of purchasing goods by chatting in the virtual space in the method of giving gifts via online networks of the present invention.

FIG. 4 is the example of the screen on which the decision of purchasing goods in the method of giving gifts via online networks of the present invention.

### DESCRIPTION OF THE PREFERRED EMBODIMENT

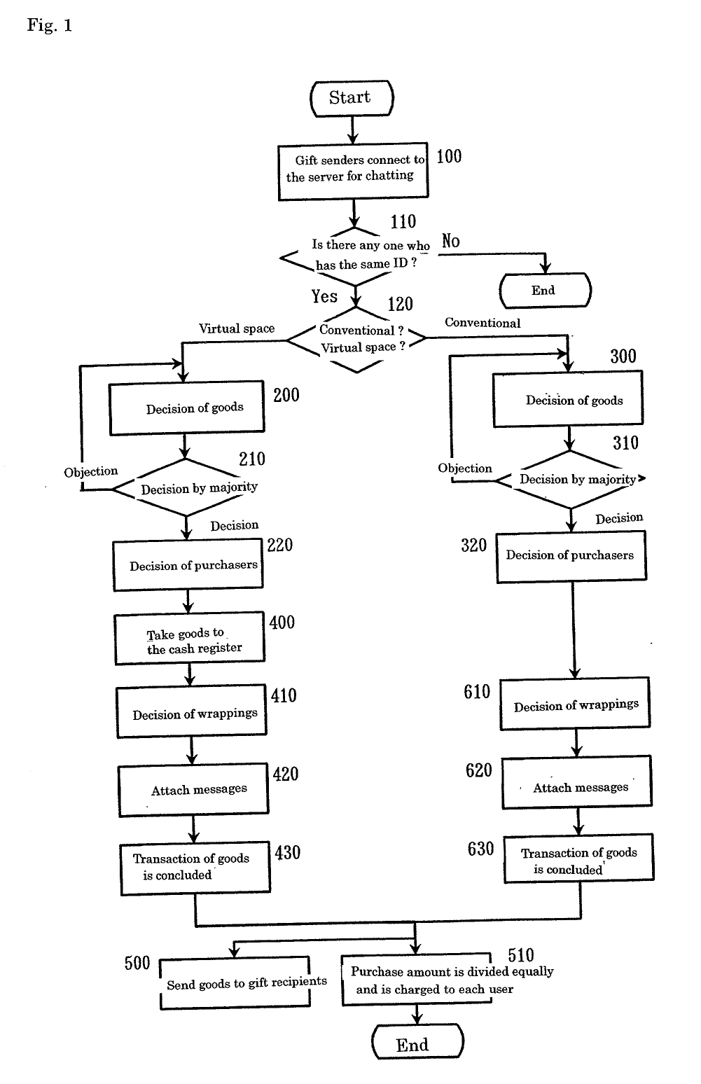

The present invention is explained in detail as follows based on the drawings. The numbers attached to FIG. 1 show each step.

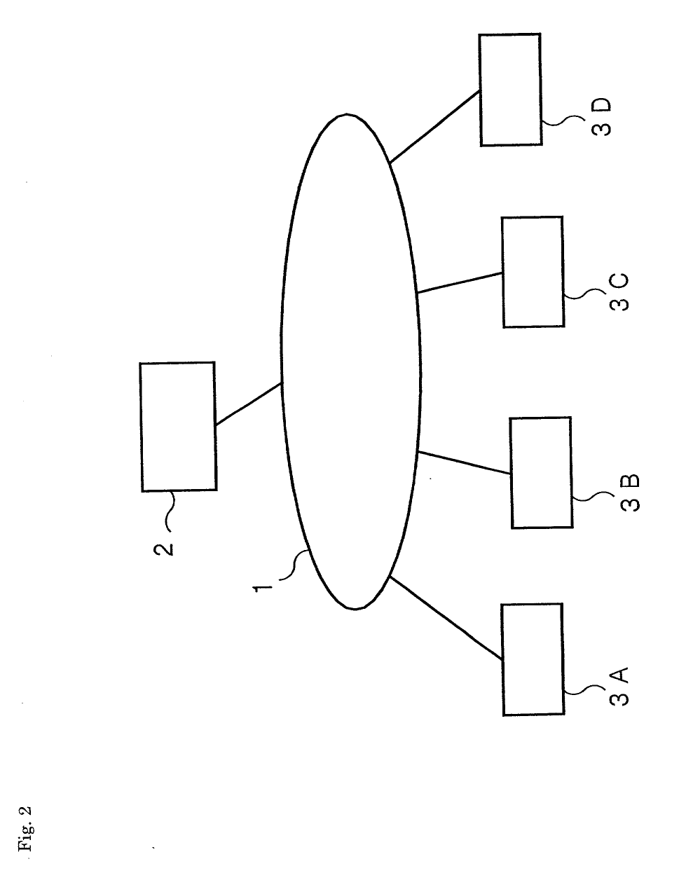

The present invention adopts a message exchanging communication system including a “chatting system” and the like where messages are exchanged among users. In such a message exchanging communication system, the virtual space can be provided. Therefore, by using the said message exchanging communication system, users can exchange messages in the virtual space and talk each other as if they met each other. Of course, it is all right to use a conventional chatting system where only character information is exchanged. FIG. 2 shows the chatting system. In FIG. 2, 1 is a communication network, where internet and intranet are preferably used. 2 is a server for chatting, 3A to 3D are network devices (including personal computers, and the like) of users A to D.

Here, the chatting on the virtual space via communication networks can be realized by installing the software (including Community Place (Trademark) manufactured by SONY Co., Ltd. ) capable of displaying the virtual space described by such languages as VRML (Virtual Reality Modeling Language) in server 2, network device 3A, and the like.

In Step 100, network device 3A and the like of gift senders (users) are connected to server for chatting 2 through communication network 1. At this stage, it is preferable that each user is authenticated, and the method for authentication is preferably the one by using IDs and passwords. In Step 110, it is confirmed that there are users having the identical group ID. Group IDs are the ones given to a group of intimate friends or circles. Therefore, when the users of the identical ID decide the date the date for chatting over e-mail, telephone, or the like, they can join chatting on the designated date and decide gifted goods to buy. Needless to say, when a gift recipient is a user of the identical group ID, he or she can join gift senders for chatting, taking a look at a process for selecting goods, stating some comments by interrupting others. And in Step 120, either chatting in the virtual space or conventional chatting is selected. Explanation goes as follows, taking an example of chatting in the virtual space.

In the system of purchasing gifts and settlement via online networks of the present invention, the users jointly own the virtual space by utilizing communication networks. This virtual space can be constructed two-dimensionally or three-dimensionally, depending on the visual viewpoint of users.

The virtual space is not specifically limited, and it may be any place in Japan or some other places in some foreign countries. Of course, since it is the virtual space, it may be the fictional space that does not exist in reality. For example, the virtual space maybe the virtual town. It is preferable that the virtual shops or stores (they may hereafter be called “virtual stores” simply)are provided with the virtual town.

In addition, users jointly own the symbols of their own that are called “avatar(s)”, symbols defined for each user in the virtual space.

Each user can operate each avatar for him or her on the network device by his or her own. For example, each user can move his or her avatar to anywhere in the virtual space. Further, each user can make their avatars talk with characters or sounds. Users can make their avatars talk with sending character information or sound information.

Thus, in the virtual space, an avatar for each user can move and talk with characters or sounds, and users can talk by using their avatars. That is, users can talk each other as if they met each other.

It is preferable that users register in the system of purchasing gifts and settlement via online networks related to the method of purchasing gifts and settlement via online networks of the present invention beforehand. Upon registration, types of avatars can be registered. Thus, by making registration beforehand, an avatar suitable for each user can be used. For example, when the user is a female, a feminine avatar can be used. Likewise, when the user is a male, a masculine avatar can be used. When the user has long hair, he or she can operate long-haired avatar. Since an avatar is a symbol of the user, to use such an avatar whose appearance is totally different from the user is possible. That is, the user can use an avatar as he or she likes.

For example, when three female friends give gifts to other female friends, it is possible to have avatars, one of whom is a long-haired female, another a short-haired female, and the other a female with a sun-tanned face, thereby making variations among users. In addition, it is possible to distinguish avatars by the clothes they wear. Thus, even when users have the same family name, depending on the preference of users, they can select and use avatars.

Therefore, in Step 200, those three feminine avatars can select gifts by having conversation, talking about the gifts for gift recipients in the virtual town as the virtual space. Therefore, the actual users can experience some feelings as if they met their friends and had conversations together although they do not meet in reality.

As described above, it is preferable that the virtual space is provided with virtual stores. The types of virtual stores are not specifically limited and they can be stores handling a large variety of goods. In other words, it is preferable that the virtual stores are provided in the virtual town and a variety of goods is on sale therein.

Thus, in the virtual stores with the virtual town provided, when three avatars enter the virtual stores, the initial screen turns to a screen showing the inside of the virtual stores, and the users can take a look at the virtual goods displayed in the virtual stores. In the virtual stores, avatars for three users can move, take the goods in their hand, have conversation each other over suitable goods and select the goods.

The embodiment can be so constructed that when an avatar takes the virtual goods in his or her hand, the specific indication about the goods appears.

When candidates for goods are specifically given, the decision is made by majority in Step 210. By the action by avatars (including raising hand), the decision by majority can be conducted. Needless to say, it is possible to decide by majority by chatting. When a candidate of goods is rejected, conversation is to be had again, going back to Step 200.

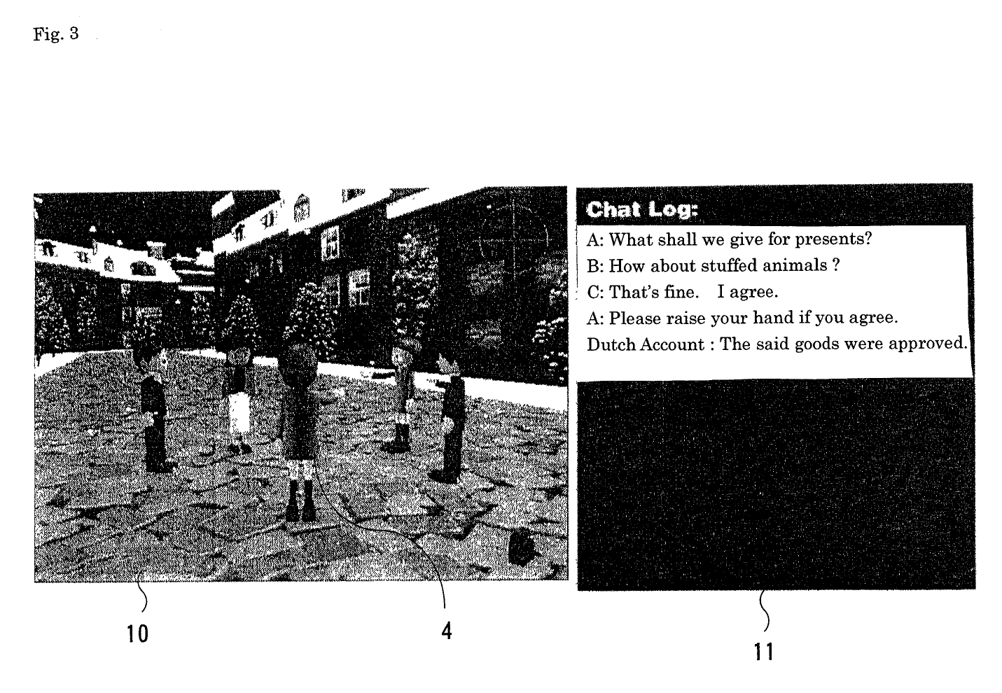

FIG. 3 shows the situation where goods are decided by chatting in the virtual space. In FIG. 3, 10 is a screen of the virtual space, 11 a screen for chatting, and 4 shows avatars of the users in the virtual space. Avatars 4 and the like are indicated on screen of virtual space 10, and the content of conversation by users A to D is indicated on screen for chatting 11. Here, in FIG. 3, five avatars are indicated, which means that they are avatars for four gift senders and one gift recipient.

In Step 220, the final will for purchasing goods is indicated by the movement of the avatars. The movement preferably includes taking a wallet, or the like. Here, when there is an objection against goods decided by majority and the avatars do not show the said movement, they are excluded out of the gift senders as they are considered to have no will to purchase the said goods. Therefore, these do not have to pay the amount.

Then, for example, the avatar related to one user puts the virtual goods into a shopping bag and puts the virtual goods on the cash register in the virtual store (Step 400). Gift senders tell the sales clerk the address to which the goods is sent actually. When the sales clerk asks wrappings and messages, the wrappings can be specified or the messages can be attached.

In other words, in Step 410, users who are gift senders can select wrappings related to goods. In particular, the embodiment is so constructed that when gift recipients are registered and when registration items of the gift recipients include their favorite colors or patterns, the wrappings can be so prepared as having colors or patterns suitable for gift recipients. Method of deciding wrappings may be done by majority or by one of gift senders as the representative.

Further, in Step 420, users who are gift senders can apply for attaching messages upon purchase of goods. Messages may be collected from all gift senders or may be prepared by each gift sender. Finally, transaction is concluded when gift senders receive goods from the sales clerk (Step 430).

When transaction is concluded, claimants for the bill charge the amount of the gifted goods equally divided to each user (Step 510). When users register the information on settlement (information on account numbers, credit card numbers, electronic money, or the like), automatic charge or withdrawal can be made. Here, it is needless to say that the amount is not divided equally but can be considered the share burden for users depending on the case.

At the same time, by sending the goods to gift recipients designated as the address to be sent, giving gifted goods from gift senders to gift recipients can be conducted (Step 500).

Needless to say, the goods sent to gift recipients by dealers handling gifts are true goods, not virtual goods.

In Step 200, various methods can be employed including recommending virtual stores or goods actively to users as well. In the present invention, as described above, it is preferable that the users register themselves. When the users register themselves, the home page for the exclusive use of them may be prepared. When the home page exclusive for the users is prepared, the users can use the virtual space effectively.

When the information of the users including their hobbies, things they want to have, things they like, or things they are interested in is registered as the information preferred by users, the stores suitable for the users or recommended for the users are indicated with priority, and the embodiment can be so constructed that the users can instantly find the stores they like to enter.

In addition, in the present invention, dealers handling gifts may indicate the stores suitable for users with priority or inform them of the recommended goods, recognizing the contents of exchanged messages displayed on the home pages of the users.

Users may also indicate the stores suitable for other users with priority or inform them of the recommended goods by answering the questionnaires prepared by the dealers handling gifts on the home pages.

In the case where dealers handling gifts indicate the stores suitable for users with priority or inform them of the recommended goods, the data base of dealers handling gifts (including data base on goods, database on psychological test, or the like) can be used.

By adopting such embodiments as described so far, in Step 200, the embodiments can be so constructed that the users can instantly find the stores they like to enter.

Even though it is the conventional chatting, not the chatting in the virtual space, the decision on goods or wrappings can be made. In other words, in Step 300, users have conversation over goods. In Step 310, the goods is specified by majority. In Step 320, the final will for purchase is indicated. Since it is not the virtual space, there is no movement to take goods to the cash register.

In Step 610, conversations are had on wrappings and wrappings are decided. The decision of wrapping may be done by majority or by one of the gift senders as the representative. In Step 620, messages attached to the goods from gift senders are prepared. Messages may be collected from all the gift senders or may be prepared by each gift sender. In Step 630, such a method by which a transaction is concluded by confirmation messages may be adopted although there is no movement to take goods to the cash register since it is not the virtual space. Then after the transaction, the amount of goods is charged equally to gift senders (Step 510) and the actual goods are sent (Step 500).

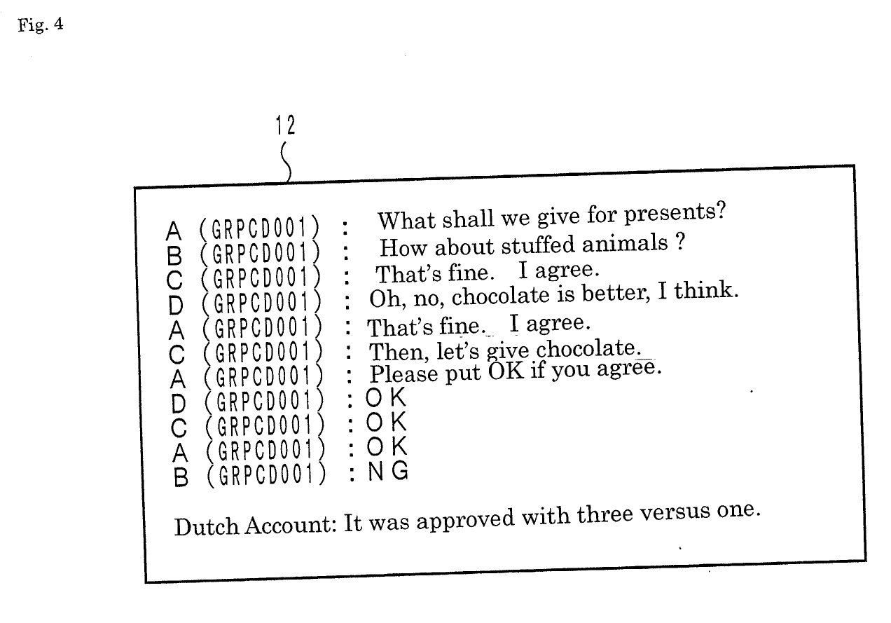

In FIG. 4, an example of a screen for chatting where the goods is going to be specified is shown. In FIG. 4, 12 shows a screen for chatting, where users A to D are in the process of specifying goods. Here, GRPDCD001 in parenthesis shows a group ID for the said users A to D.

So far, the explanation was made as for giving goods. The method, however, can also be applied for co-purchasing goods which co-purchasers jointly own. In this case, the destination of goods is addressed to one of the said co-purchasers and the said destination may be specified upon purchasing goods.

In the method of giving gifts via online networks of the present invention, even when users are far apart each other, they can decide what goods to buy by taking a look at goods, looking for it, and having conversation over it. Since the method integrates communication and sales, the users can enjoy selecting goods.

In addition, in the method of settlement via online networks of the present invention, since the claimants charge the amount equally divided to each user, it saves paying for the purchasing amount and collecting it.

Here, the present invention includes the identical subject matter disclosed in the specification, claims of Japanese Patent application No. 2000-067826 to which is claimed priority for the present application.

What is claimed is:

1. A method of giving gifts via online networks giving gifts by using communication networks wherein the users who are gift senders jointly own the virtual space and the symbols defined for each user in the said virtual space, and by exchanging messages in this virtual space, the users or gift senders select and give gifts to gift recipients.

2. A method of giving gifts via online networks as set forth in claim 1 wherein at least a virtual store is provided in the virtual space and gift senders select and give gifts to gift recipients by using the said virtual store.

3. A method of giving gifts via online networks as set forth in claim 1 wherein dealers handling gifts charge the amount for purchasing gifts by automatically dividing the amount equally.

4. A method of purchasing goods via online networks purchasing goods jointly purchased by using communication networks wherein the users who are co-purchasers jointly own the virtual space and the symbols defined by each user in the said virtual space, and by exchanging messages in this virtual space, the users or co-purchasers select and purchase goods jointly purchased.

5. A method of purchasing goods via online networks as set forth in claim 4 wherein at least a virtual store is provided in the virtual space and co-purchasers select and purchase goods jointly purchased by using the said virtual store.

6. A method of purchasing goods via online networks as set forth in claim 4 wherein dealers handling gifts charge the amount for goods jointly purchased by automatically dividing the amount equally.

7. A method of settlement via online networks wherein dealers handling gifts charge the amount for gifts by automatically dividing the amount equally.
